(19) United States
(12) Patent Application Publication
(10) Pub. No.: US 2024/0144022 A1
(43) Pub. Date: May 2, 2024

(54) Systems and Methods for Model Training Based on Feature Fusion of Multiple Data Types

(71) Applicant: GOOGLE LLC, Mountain View, CA (US)

(72) Inventors: Girija Narlikar, Mountain View, CA (US); Yemao Zeng, Mountain View, CA (US); Raghuveer Chanda, Mountain View, CA (US); Abhishek Sethi, Mountain View, CA (US)

(21) Appl. No.: 18/394,615

(22) Filed: Dec. 22, 2023

Related U.S. Application Data
(63) Continuation of application No. 17/297,839, filed on May 27, 2021.

(51) Int. Cl. G06N 3/09

(52) U.S. Cl. CPC G06N 3/09

(57) ABSTRACT

A method includes receiving first data elements of a first data type and second data elements of a second data type. The first data type is text data and the second data type is at least one of image data or video data. The method also includes identifying first features of each of the first data elements, identifying second features of each of the second data elements, and generating merged features by combining a first feature of the first features of each of the first data elements with a second feature of the second features of one of the second data elements. The first feature and the second feature each represent a common feature. The method also includes generating a model based on the common features and at least a portion of the first features and the second features.

### CROSS-REFERENCE TO RELATED APPLICATIONS

This is a continuation of U.S. patent application Ser. No. 17/297,839, filed on May 27, 2021, which is a national stage entry of PCT Patent Application No. PCT/US2020/042006, filed on Jul. 14, 2020. The entire disclosure of each of the above-identified applications is hereby incorporated herein by reference BACKGROUND

The present disclosure relates generally to model training based on data of multiple modalities. Some content items may include multiple pieces of content, for example, an image and text. However, the image and text both belong to a different data modalities. A model that classifies content items of multiple data modalities can be trained based on data from the data modalities.

Some training methods for training a classification model can assume data points across multiple modalities to be directly linked (e.g., captions for videos or clinical notes for lab reports) to leverage zero-shot learning. Alternatively, some training methods may jointly train multiple types of content data (e.g., images, videos, HTML5, application data, etc.) in the same embedding space. These training methods require the presence of a large amount of labeled multimedia data (e.g., image and/or video data), or multimedia implicitly labeled by its proximity to other content types. This large amount of data may not be available, especially in the case of image based content where a significant amount of user review and manual classification may be required. Furthermore, video based content may take a significant amount of user review time for classification, and hence an increased cost.

### SUMMARY

In general, one innovative aspect of the subject matter described in this specification can be implemented in methods that includes a method including receiving, by one or more processing circuits, first data elements of a first data type and second data elements of a second data type, wherein the first data type is text data and the second data type is at least one of image data or video data. The method includes identifying, by the one or more processing circuits, first features of each of the first data elements and identifying, by the one or more processing circuits, second features of each of the second data elements. The method includes generating, by the one or more processing circuits, merged features by combining a first feature of the first features of each of the first data elements with a second feature of the second features of one of the second data elements, wherein the first feature and the second feature each represent a common feature, training, by the one or more processing circuits, a model based on the merged features and at least a portion of the first features and the second features, and classify a content item based on the model, wherein the content item includes content text and at least one of a content image or a content video. In some embodiments, the content item includes image data features fused with video data features instead of, or in addition to, text features.

In general, another aspect of the subject matter described in this specification can be found in a system including one or more memory devices configured to store instructions thereon, that, when executed by one or more processors, cause the one or more processors to receive first data elements of a first data type and second data elements of a second data type, identify first features of each of the first data elements, and identify features of each of the second data elements. The instructions cause the one or more processors to generate merged features by combining a first feature of the first features of each of the first data elements with a second feature of the second features of one of the second data elements, wherein the first feature and the second feature each represent a common feature and train a model based on the merged features and at least a portion of the first features and the second features.

In general, another aspect of the subject matter described in this specification can be implemented in one or more computer readable storage media configured to store instructions thereon that, when executed by one or more processors, cause the one or more processors to receive first data elements of a first data type and second data elements of a second data type, identify first features of each of the first data elements, and identify second features of each of the second data elements. The instructions cause the one or more processors to generate merged features by combining a first feature of the first features of each of the first data elements with a second feature of the second features of one of the second data elements, wherein the first feature and the second feature each represent a common feature and train a model based on the merged features and at least a portion of the first features and the second features.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system including a model manager and a merge function that implement feature merging of multiple data types for model training according to an illustrative implementation.

FIG. 2 is a block diagram of the model manager of FIG. 1 shown in greater detail according to an illustrative implementation.

FIG. 3 is a block diagram of the merge function of FIG. 1 shown generating training data for training a model according to an illustrative implementation.

FIG. 4 is a block diagram of the merge function of FIG. 1 shown generating merged features for inferring a classification with the model trained as shown in FIG. 3 according to an illustrative implementation.

FIG. 5 is a flow diagram of a process of training the model of FIG. 1 with merged features generated by the merge function of FIG. 1 according to an illustrative implementation.

FIG. 6 is a flow diagram of a process of generating a model output with the model of FIG. 1 where the merge function provides merged features to the model according to an illustrative implementation.

FIG. 7 is a block diagram of a computing system according to an illustrative implementation.

### DETAILED DESCRIPTION

Referring generally to the Figures, various illustrative systems and methods are provided that can be used for machine learning (ML) classifiers for classifying content items that include multiple content types, e.g., images, text, audio, videos, HTML5 data, application data, etc. For example, a content item might include a text description of a product in combination with a video or image of the product. Furthermore, the present disclosure relates more particularly to training classifiers when there is significantly more labeled training data of one content type than another content type, for example, when there is more labeled text data than image data and/or video data. While there may be a high amount of text based training data available, acquiring image and/or video training data may be difficult since it may require manual review of images and/or videos by a person.

In this regard, labeled data for one content type (e.g., text) can be leveraged to develop classifiers for content items including multiple types of content when there is not a significant amount of training data for another content type (e.g., image or video). The systems described herein are configured to build classifiers for content items that include multiple content types quickly, without collecting a large amount of human labeled training data for each of the content types.

The present systems and methods utilize a common feature space that is formed from data of different domains (alternatively referred to as data types or modalities). A system can be configured to merge features from different domains at an early stage of training. The merged features can be used by the system to train a joint model that classifies content items including multiple content types. The features can be extracted from the multiple content types and merged to form the common feature space. This merging can be referred to as “early fusion” since features are merged early in the machine learning training pipeline. The system can further utilize text only and image only features, features which are not combined are unique to the text or image respectively. Classifiers trained with early fusion outperform models that are trained on solely text data or solely image data.

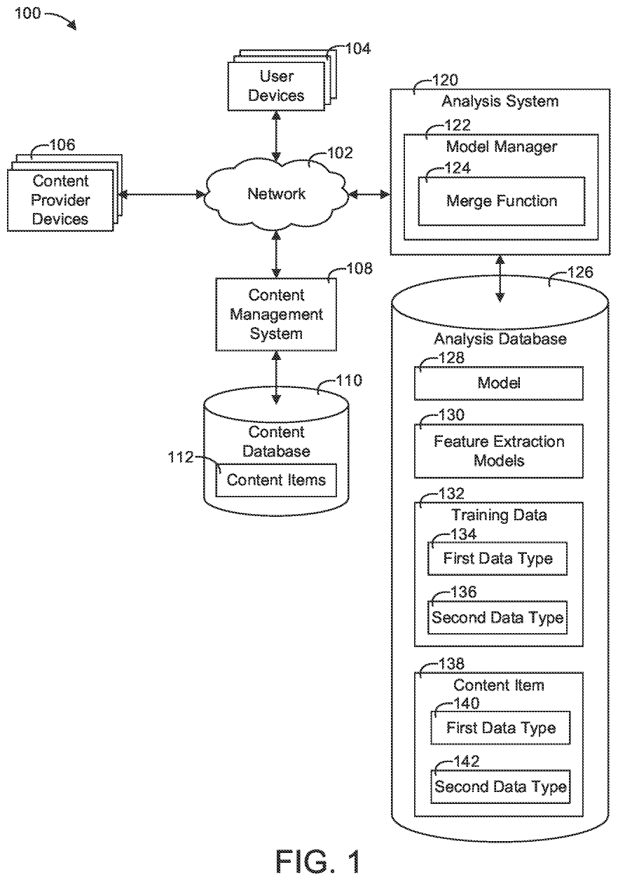

The system can be configured to train a classifier model by taking data from both images and text to build a classifier model. The system can be configured to extract common features from different content types. These common features can be plain text (e.g., overlay text on images, text derived from speech recognition on video, etc.), categorical features, or numerical features computed using machine learning models. FIGS. 1-6 illustrate the training and inference of the classifier model trained with early fusion.

The system can be configured to receive content items from a content provider and can be configured to apply the trained classifier trained with early fusion to classify the content items. In some embodiments, the output of the classifier model can determine whether the content items should be served to users, withheld from users, or have a restriction placed on what users or websites the content items are served on.

Data for training the classifier model could be content item data for serving to an end user while models used to extract features from the content item data could be trained based on search data. The corpus size for training models to extract the features from the content items may be one or more orders of magnitude larger than the total number of content items used to train the classifier model. The content item corpus, although smaller, may be important as the content item corpus belongs to the domain that the classifier is trained for, that is, they are real content items. Further, these content items may have classification labels (e.g., policy labels) assigned by human reviewers. The model shown can be trained only on image and text content. The features that feed into the policy classification model can be extracted by models trained on search data. The early fusion can be useful for any task that needs to classify data from multiple domains that have a shared (or partially shared) set of features.

Referring now to FIG. 1, a block diagram of an analysis system 120 and associated environment 100 is shown according to an illustrative implementation. One or more user devices 104 may be used by a user to perform various actions and/or access various types of content, some of which may be provided over a network 102 (e.g., the Internet, LAN, WAN, etc.). A “user” or “entity” used herein may refer to an individual operating user devices 104, interacting with resources or content items via the user devices 104, etc. The user devices 104 may be used to access websites (e.g., using an internet browser), media files, and/or any other types of content. A content management system 108 may be configured to select content for display to users within resources (e.g., webpages, applications, etc.) and to provide content items to the user devices 104 over the network 102 for display within the resources. The content from which the content management system 108 selects items may be provided by one or more content providers via the network 102 using one or more content provider devices 106.

In some implementations, the content management system 108 may select content items from content providers to be displayed on the user devices 104. In such implementations, the content management system 108 may determine content to be published in one or more content interfaces of resources (e.g., webpages, applications, etc.). The content management system 108 can be configured to conduct a content auction among third-party content providers to determine which third-party content is to be provided to the user device 104. The auction winner can be determined based on bid amounts and a quality score (i.e., a measure of how likely the user of the user device 104 is to click on the content). In some implementations, the content management system 108 allows content providers to create content campaigns. A campaign can include any number of parameters, such as a minimum and maximum bid amount, a target bid amount, and/or one or more budget amounts (e.g., a daily budget, a weekly budget, a total budget, etc.).

The analysis system 120 can include one or more processors (e.g., any general purpose or special purpose processor), and can include and/or be operably coupled to one or more transitory and/or non-transitory storage mediums and/or memory devices (e.g., any computer-readable storage media, such as a magnetic storage, optical storage, flash storage, RAM, etc.). In various implementations, the analysis system 120 and the content management system 108 can be implemented as separate systems or integrated within a single system (e.g., the content management system 108 can be configured to incorporate some or all of the functions/capabilities of the analysis system 120).

The analysis system 120 can be communicably and operatively coupled to the analysis database 126. The analysis system 120 can be configured to query the analysis database 126 for information and store information in the analysis database 126. In various implementations, the analysis database 126 includes various transitory and/or non-transitory storage mediums. The storage mediums may include but are not limited to magnetic storage, optical storage, flash storage, RAM, etc. The analysis database 126 and/or the analysis system 120 can use various APIs to perform database functions (i.e., managing data stored in the database 126). The APIs can be but are not limited to SQL, ODBC, JDBC, etc.

Analysis system 120 can be configured to communicate with any device or system shown in environment 100 via network 102. The analysis system 120 can be configured to receive information from the network 102. The information may include browsing histories, cookie logs, television advertising data, printed publication advertising data, radio advertising data, and/or online advertising activity data. The analysis system 120 can be configured to receive and/or collect the interactions that the user devices 104 have on the network 102.

The analysis system 120 can be configured to send information and/or notifications relating to various metrics or models it determines, generates, or fits to the content provider devices 106. This may allow a user of one of the content provider devices 106 to review the various metrics or models which the analysis system 120 determines. Further, the analysis system 120 can use the various metrics to identify opportune times to make contact with a user or appropriate amounts (e.g., an optimal mixed media spend) to spend on various media channels (e.g., television advertising, Internet advertising, radio advertising, etc.). The analysis system 120 can cause a message to be sent to the content management system 108 and/or the content provider devices 106 indicating that the content management system 108 should make contact with a certain user at a certain time and/or a content campaign operate with certain parameters. This may cause the content management system 108 to manage content auctions accordingly and/or identify various system loads.

The analysis system 120 may include one or more modules (i.e., computer-readable instructions executable by a processor) and/or circuits (i.e., ASICs, Processor Memory combinations, logic circuits, etc.) configured to perform various functions of the analysis system 120. In some implementations, the modules may be or include a model manager 122 and a merge function 124. The model manager 122 can be configured to train a model 128 stored in the analysis database 126 based on the training data 132. The training data 132 includes data of a first data type 134 and a second data type 136. The first data type 134 and the second data type 136 can each be one of image data, text data, video data, audio data, etc. In some embodiments, the first data type 134 and the second data type 136 are separate data types, e.g., the first data type 134 is image data and the second data type 136 is text data. In some embodiments, the first data type 134 and the second data type 136 are the same data type but received from separate data sources, e.g., an image received from a product manufacturer and a second image received from a website selling the product.

In some embodiments, the model manager 122 is configured to perform early fusion. The model manager 122 can be configured to merge features of multiple data modalities to create a single common feature space for training the model 128. Features shared by multiple data modalities can be merged into a single feature. The data may be data of raw text from text posts, captions derived from image data points or videos, audio data, and/or any other data. Furthermore, features specific to certain data modalities can be applied to the model 128 instead of being combined (e.g., image specific embeddings will not be present in text data). In some embodiments, the data modalities and label sources can be jointly trained.

The model manager 122 can be configured to apply feature extraction models 130 to the training data 132 to extract features of the first data type 134 and the second data type 136. The merge function 124 can be configured to identify common features between the first data type 134 and the second data type 136 and merge the common features to generate merged features. The model manager 122 can be configured to apply the merged features and/or unique features of the first data type 134 and the second data type 136 as the training data to train the model 128.

With the trained model 128, the model manager 122 can be configured to classify a content item 138. The content item 138 includes data of different data types, the first data type 140 and the second data type 142. The first data type 140 and the second data type 142 can each be one of image data, text data, video data, audio data, etc. The model manager 122 can be configured to apply the feature extraction models 130 to the content item 138 to extract features from the first data type 140 and the second data type 142.

The content item 138 can be the same as or similar to the content items 112. In some embodiments, the content provider devices 106 and/or the user devices 104 can provide the content item 138 to the analysis system 120 for serving to users. However, before the content item 138 can be added to the content database 110 to be served to users, the analysis system 120 may determine a policy classification for the content item 138. The policy classification may identify restrictive information for the content item 138. The restrictive information may identify what types of users the content item 138 should be served to, what types of web pages the content item 138 should be served to, and/or any other restrictive information.

The merge function 124 can be configured to merge common features extracted by the feature extraction models 130 to generate merged features. The model manager 122 can apply unique features of the first data type 140, unique features of the second data type 142, and the merged features to the model 128 to generate a classification for the content item 138. The result of applying the content item 138 to the model 128 may be a classification for the content item 138. The policy classification may be an indication of rules for serving the content item 138. The rules may indicate certain types of users or webpages that the content item 138 can be served on.

In some embodiments, the model 128 is a neural network. The neural network may be a recurrent neural network, a convolutional neural network, a long-short term memory neural network, a gated recurrent unit neural network, an auto encoder neural network, a variation auto encoder neural network, and/or any other type or combination of neural network types. In some embodiments, the model 128 is a non-linear support vector machine, a random forest, a gradient boosting tree, a decision tree, a Bayesian network, a Hidden Markov Model, and/or any other type of model.

The feature extraction models 130 can be various types of models that extract features from the training data 132 and/or the content item 138. For example, the feature extraction models 130 can be speech recognition models, an image embedding model, a video embedding model, an object recognition models, optical character recognition (OCR), and/or any other type of feature recognition models. The feature extraction models 130 can be trained on the training data 132 by the model manager 122.

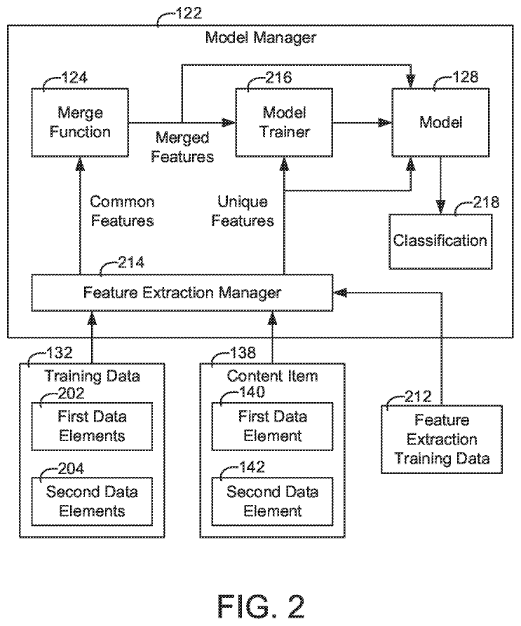

Referring now to FIG. 2, the model manager 122 of FIG. 1 shown in greater detail according to an illustrative implementation. The model manager 122 receives the training data 132. The model manager 122 can be configured to train the model 128 based on the training data 132. Furthermore, the model manager 122 receives the content item 138. The model manager 122 can cause the model 128 to generate a classification 218 for the content item 138 where the model 128 is trained based on the training data 132.

The model manager 122 includes a feature extraction manager 214. The feature extraction manager 214 can be configured to extract features of the first data elements 202, the second data elements 204, the first data type 140, and/or the second data type 142. In some embodiments, the feature extraction manager 214 can identify common features between the first data elements 202 and the second data elements 204. In some embodiments, the feature extraction manager 214 can identify common features between the first data types 140 and the second data types 142.

Furthermore, the feature extraction manager 214 can extract unique features from the training data 132 and/or the content item 138. The unique features may be features that only appear in one of the first data elements 202 or the second data elements 204 or alternatively the first data type 140 or the second data type 142. In this regard, features that only appear in one data type and not the other data type can be applied to the model trainer 216 for training the model 128 or alternatively to the model 128 for inferring the classification 218.

The feature extraction manager 214 can be configured to compare features extracted from the first data elements 202 and the second data elements 204 to determine whether any of the features represent the same feature, i.e., are common features. For example, the feature extraction manager 214 could extract a text feature representing a golf club in a content item for golf equipment. The extraction manager 214 could extract image features from an image of the content item, for example, the content item may include various images of golf equipment, e.g., golf clubs, golf balls, golf gloves. The feature extraction manager 214 could identify image features for the golf clubs, the golf balls, and/or the golf gloves. The feature extraction manager 214 can be configured to identify the common features, i.e., the image based feature of the golf clubs and the text feature of the golf club, and provide the common features to the merge function 124 for generating the merged features.

The feature extraction manager 214 can be configured to train feature extraction models (e.g., the feature extraction models 130) that extract the features from the training data 132 and/or the content item 138. For example, the feature extraction manager 214 can include object feature extraction models, e.g., convolutional neural networks, that extract features from images, audio processing models that identify audio features, optical character recognition models that extract characters from images, text processing features that identify text features from text data, etc. The models can be trained by the feature extraction manager 214 based on the features extraction training data 212.

The merge function 124 can be configured to merge the common features identified by the feature extraction manager 214. The merge function 124 can combine common features. For example, each of the features may have a metric or other value associated with a feature. For example, for a golf club feature, the metric may indicate a likelihood that the identified golf club is a golf club. The merge function 124 can combine the metric associated with each common feature by applying a mathematical operation. For example, the operation can include summation, subtraction, multiplication, averaging, determining a median, etc. The output of the merge function can be the metric output by applying the mathematical operation.

The model manager 122 includes the model trainer 216. The model trainer 216 can be configured to train the model 128 based on the merged features received from the merge function 124 and/or the unique features extracted by the feature extraction manager 214. The model trainer 216 can be configured to perform gradient descent, conjugate gradient, Newton method, quasi Newton, Levenberg Marquardt, etc. In some embodiments, the training data 132 includes a policy classification for each of the first data elements 202 and/or the second data elements 204. Based on the classification and the first data elements 202 and the second data elements 204, the model trainer 216 can train the model 128.

With the trained model 128, the model manager 122 can apply the content item 138 to the model 128 to generate the classification 218. The feature extraction manager 214 can be configured to extract the common features from the first data type 140 and the second data type 142. Furthermore, the merge function 124 can merge the common features and apply the merged features to the model 128 for inferring the policy classification 218. Furthermore, the feature extraction manager 214 can extract the unique features from the first data type 140 and the second data type 142 and apply the unique features to the model 128 to generate the policy classification 218.

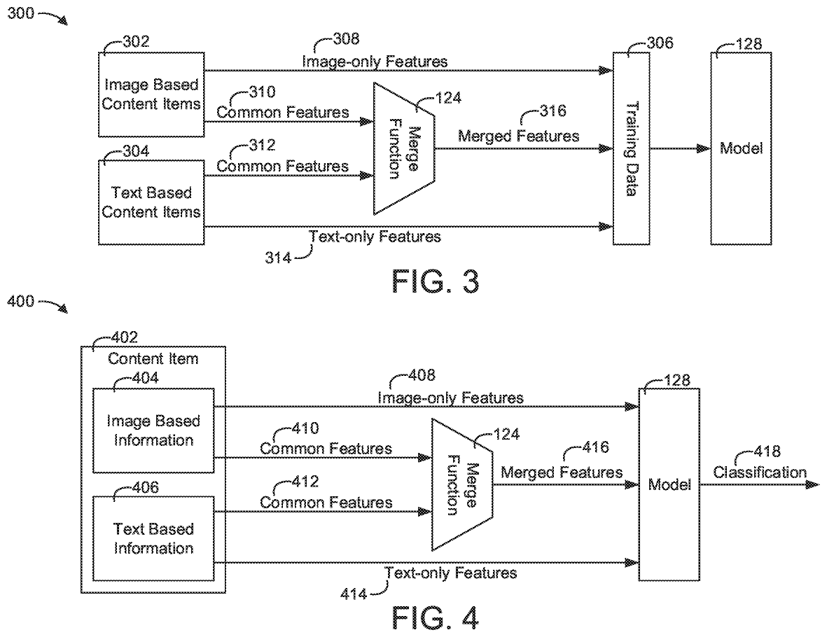

Referring now to FIG. 3, a system 300 of the merge function is shown generating training data for training a model according to an illustrative implementation. The system 300 includes image based content items 302 and text based content items 304. The model manager 122 can generate the training data 306 and train the model 128 based on the training data 306. The model manager 122 can be configured to extract the image-only features 308 from the image based content items 302 and the text-only features 314 from the text based content items 304. The image-only features 308 may be features that only appear in the image based content items 302 and not the text based content items 304.

For example, image-only features 308 could be indications of the colors used in the image based content items 302, certain shapes or objects that appear in the image based content items 302, and/or any other information that does not appear in the text based content items 304. The text-only features 314 could be indications of product prices, number of products sold together, product use instructions, or other product details not indicated in the image based content items 302. Furthermore, the model manager 122 can extract the common features 310 and 312 from the image based content items 302 and the text based content items 304.

The merge function 124 can merge the common features 310 and 312 to generate the merged features 316. The merged features 316 can be included in the training data 306 for training the model 128. The merged features 316 can be generated from the common features 310 and 312. For example, for a common feature of the image based content items 302 and a common feature of the text based content items 304, the merge function 124 can apply a mathematical operation to the values associated with each content item. The values may be confidences or probabilities that a feature is identified in the data. For example, if a golf club feature is associated with a 0.9 probability from an image based content item and the golf club feature is associated with a 0.5 probability from a text based content item, the merge function 124 could apply a mathematical operation to the probabilities to generate a merged feature for the golf club. For example, the merge function 124 could average the two probability values to generate a probability of 0.7.

Based on the training data 306 formed from the image-only features 308, the merged features 316, and the text-only features 314, the model manager 122 can be configured to train the model 128. More particularly, the model trainer 216 can train the model 128 based on the training data 306. With the model 128 trained as shown in FIG. 3, inferences can be determined as shown in FIG. 4.

Referring now to FIG. 4, a system 400 including the merge function 124 generating merged features for inferring a classification with the model trained as shown in FIG. 3 according to an illustrative implementation. A content item 402 is applied to the model 128. The content item 402 can be the same as, or similar to, the content item 138. The content item 402 includes image based information 404 and text based information 406. In some embodiments, the image based information 404 includes one or more images or video information of a product. In some embodiments, the text based information 406 includes a textual description of the product. The image-only features 408, the common features 410, the common features 412, and/or the text-only features 414 can be similar to the image-only features 308, the common features 310, the common features 312, and the text-only features 314.

The feature extraction manager 214 can be configured to extract the image-only features 408, the common features 410, the common features 412, and/or the text-only features 414. The common features 410 and 412 can be applied to the merge function 124. The merge function 124 can combine the common features 410 and 412 to generate the merged features 416. The image-only features 408, the merged features 416, and the text-only features 414 can be applied to the model 128 to generate the classification 418. The classification 418 can be a classification of the content item 402. The classification 418 can be a policy for providing the content item 402 to users.

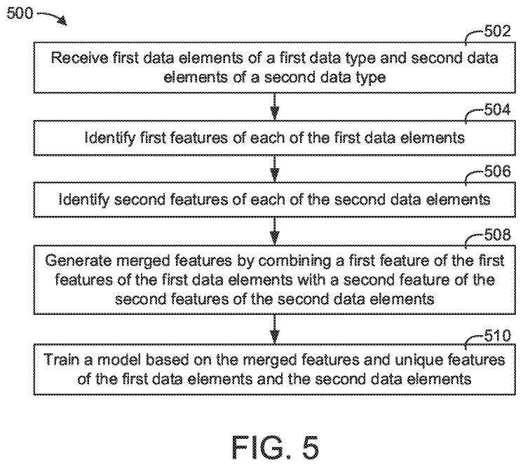

Referring now to FIG. 5, is a block diagram of flow diagram of a process 500 of training a model with merged features generated by the merge function of FIG. 1 according to an illustrative implementation. In some embodiments, the process 500 is performed by the model manager 122. In some embodiments, the process 500 is performed by the computer system 700. In some embodiments, any computing system as described herein can be configured to perform the process 500.

In step 502, the model manager 122 receives first data elements of a first data type and second data elements of a second data type. In some embodiments, the first data elements and the second data elements are the training data 132. The first data type and the second data type may each be a different data type of one of at least image data, video data, text data, audio data, etc.

In step 504, the model manager 122 identifies first features of each of the first data elements. In some embodiments, the model manager 122 applies the feature extraction manager 214 to the first data elements of step 502 to generate common features and unique features of the first data elements. In step 506, the model manager 122 identifies second features of each of the second data elements. In some embodiments, the model manager 122 applies the feature extraction manager 214 to the second data elements of step 502 to generate common features and unique features of the second data elements.

In step 508, the model manager 122 generates merged features by combining a first feature of the first features of the first data elements with a second feature of the second features of the second data elements. The first feature and the second feature may represent a common feature. The merge function 124 can merge the common features to generate merged features. In some embodiments, the merge function 124 can apply a mathematical operation such as addition, averaging, taking a median, subtraction, etc. on the common features to generate the merged features.

In step 510, the model manager 122 trains a model based on the merged features and unique features of the first data elements and the second data elements. For example, the model manager 122 can train the model 128 based on the training data 306. In some embodiments, the model trainer 216 is configured to perform the training.

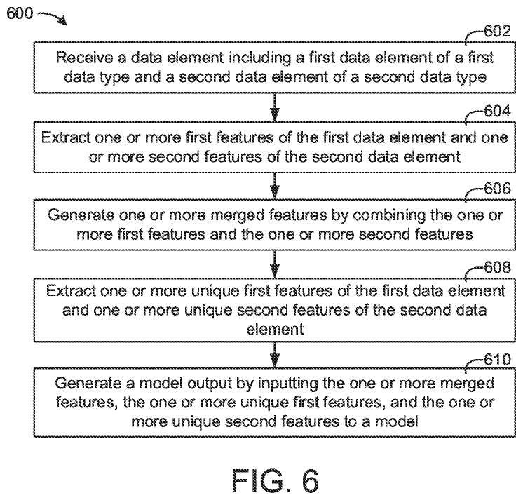

Referring now to FIG. 6 is a block diagram of flow diagram of a process of generating a model output with a model where the merge function provides merged features to the model according to an illustrative implementation. In some embodiments, the process 600 is performed by the model manager 122. In some embodiments, the process 600 is performed by the computer system 700. In some embodiments, any computing system as described herein can be configured to perform the process 600.

In step 602, the model manager 122 receives a data element including a first data element of a first data type and a second data element of a second data type. The data element may be the content item 402 including the image based information 404 and the text based information 406.

In step 604, the model manager 122 extracts on or more first features of the first data element and one or more second features of the second data element. The first features and the second features can be common features and can be extracted by the feature extraction manager 213. In step 608, the model manager 122 can generate one or more merged features by combining the one or more features and the one or more second features. In some embodiments, the merge function 124 can receive the one or more first features and the one or more second features and merge the features to generate the merged features. For example, in some embodiments, the model manager 122 can apply the merge function 124 to the merge the common features to generate the merged features.

In step 608, the model manager 122 can extract one or more unique first features of the first data element and one or more unique second features of the second data element. In some embodiments, the unique features each appear in one of the first data elements and the second data elements but not the other data element and are not common. In step 610, the model manager 122 can generate a model output by inputting the one or more merged features determined in the step 606 and the unique features of the step 608. In some embodiments, the model manager 122 applies the common and unique features to the model 128 to generate the policy classification 218.

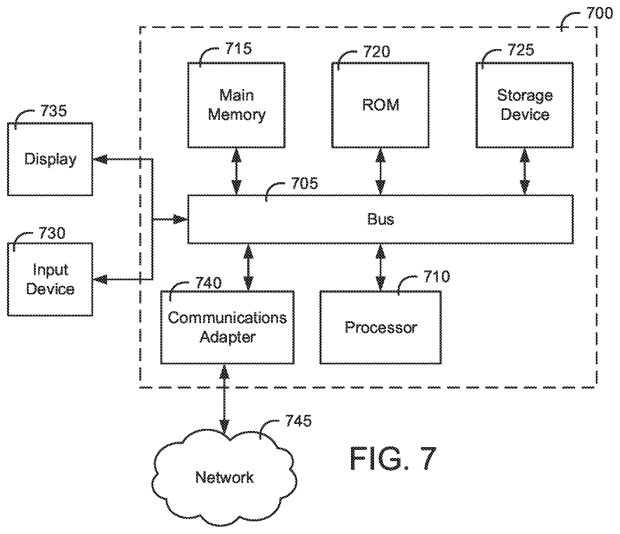

Referring now to FIG. 7, a computer system 700 is shown that can be used, for example, to implement an illustrative user device 104, an illustrative content management system 108, an illustrative content provider device 106, an illustrative analysis system 150, and/or various other illustrative systems described in the present disclosure. The computing system 700 includes a bus 705 or other communication component for communicating information and a processor 710 coupled to the bus 705 for processing information. The computing system 700 also includes main memory 715, such as a random access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 720 or other static storage device coupled to the bus 705 for storing static information and instructions for the processor 710. A storage device 725, such as a solid state device, magnetic disk or optical disk, is coupled to the bus 705 for persistently storing information and instructions.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information, and command selections to the processor 710. In another implementation, the input device 730 has a touch screen display 735. The input device 730 can include a cursor control, such as a mouse, a trackball, or cursor direction keys, for communicating direction information and command selections to the processor 710 and for controlling cursor movement on the display 735.

In some implementations, the computing system 700 may include a communications adapter 740, such as a networking adapter. Communications adapter 740 may be coupled to bus 705 and may be configured to enable communications with a computing or communications network 745 and/or other computing systems. In various illustrative implementations, any type of networking configuration may be achieved using communications adapter 740, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to implement illustrative implementations. Thus, implementations are not limited to any specific combination of hardware circuitry and software.

Although an example processing system has been described in FIG. 7, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TELEVISION channel, on a satellite TELEVISION channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more processing circuits, a plurality of first data elements of a first data type and a plurality of second data elements of a second data type, wherein the first data type is text data and the second data type is at least one of image data or video data;
identifying, by the one or more processing circuits, first features of each of the plurality of first data elements;
identifying, by the one or more processing circuits, second features of each of the plurality of second data elements;
generating, by the one or more processing circuits, merged features by combining a first feature of the first features of each of the plurality of first data elements with a second feature of the second features of one of the plurality of second data elements, wherein the first feature and the second feature each represent a common feature; and
generating, by the one or more processing circuits, a model based on the common features and at least a portion of the first features and the second features.

2. The method of claim 1, wherein:
each of the plurality of first data elements is associated with one of the plurality of second data elements; and
generating the merged features includes combining the first feature of the first features of each of the plurality of first data elements with the second feature, of the second features of the one of the plurality of second data elements, that each of the plurality of first data elements is associated with.

3. The method of claim 1, wherein:
identifying the first features and identifying the second features includes applying one or more models to the plurality of first data elements and the plurality of second data elements; and
the one or more models extract the first features from the plurality of first data elements and extract the second features from the plurality of second data elements.

4. The method of claim 3, wherein the one or more models include at least one of an image embedding model, a video embedding model, an object recognition model, an audio translation model, and an optical character recognition model.

5. The method of claim 1, wherein combining the first feature with the second feature includes performing an operation on (i) a first value of the first feature representing a first confidence of the first feature and (ii) a second value of the second feature representing a second confidence of the second feature.

6. The method of claim 5, wherein the operation is at least one of:
a maximum operation that selects a maximum of the first value and the second value;
a summation operation that sums the first value and the second value;
a median operation that determines a median of the first value and the second value; and
a minimum operation that selects a minimum of the first value and the second value.

7. The method of claim 1, further comprising:
receiving, by the one or more processing circuits, a data element comprising a first data element of the first data type and a second data element of the second data type;
extracting, by the one or more processing circuits, first inference features of the first data element and second inference features of the second data element;
generating, by the one or more processing circuits, one or more merged features by combining one or more of the first inference features with one or more of the second inference features, wherein each of the one or more of the first inference features is a particular common feature to one of the one or more of the second inference features;
identifying, by the one or more processing circuits, unique first classification features of the first classification features unique to the first data type;
identifying, by the one or more processing circuits, unique second classification features of the second classification features unique to the second data type; and
generating, by the one or more processing circuits, a model output of the model by applying the one or more merged features, the unique first classification features, the unique second classification features as inputs to the model.

8. The method of claim 1, wherein:
the first data type is a text based data type and the second data type is at least one of an image data type or a video data type.

9. The method of claim 8, wherein:
at least a first portion of the plurality of first data elements are associated with first data element labels and at least a second portion of the plurality of second data elements are associated with second data element labels;
a first number of the first data element labels is greater than a second number of the second data element labels; and
the method further comprises training, by the one or more processing circuits, the model based on the first data element labels and the second data element labels.

10. The method of claim 8, wherein:
at least a first portion of the plurality of first data elements are associated with first data element labels and none of the plurality of second data elements are associated with second data element labels; and
the method further comprises training, by the one or more processing circuits, the model based on the first data element labels.

11. A system comprising one or more memory devices storing instructions that, when executed by one or more processors, cause the one or more processors to:
receive a plurality of first data elements of a first data type and a plurality of second data elements of a second data type, wherein the first data type is text data and the second data type is at least one of image data or video data;
identify first features of each of the plurality of first data elements;
identify second features of each of the plurality of second data elements;
generate merged features by combining a first feature of the first features of each of the plurality of first data elements with a second feature of the second features of one of the plurality of second data elements, wherein the first feature and the second feature each represent a common feature; and
generate a model based on the common features and at least a portion of the first features and the second features.

12. The system of claim 11, wherein:
each of the plurality of first data elements is associated with one of the plurality of second data elements; and
generating the merged features includes combining the first feature of the first features of each of the plurality of first data elements with the second feature, of the second features of the one of the plurality of second data elements, that each of the plurality of first data elements is associated with.

13. The system of claim 11, wherein:
identifying the first features and identifying the second features includes applying one or more models to the plurality of first data elements and the plurality of second data elements; and
the one or more models extract the first features from the plurality of first data elements and extract the second features from the plurality of second data elements.

14. The system of claim 13, wherein the one or more models include at least one of an image embedding model, a video embedding model, an object recognition model, an audio translation model, and an optical character recognition model.

15. The system of claim 11, wherein combining the first feature with the second feature includes performing an operation on (i) a first value of the first feature representing a first confidence of the first feature and (ii) a second value of the second feature representing a second confidence of the second feature.

16. The system of claim 15, wherein the operation is at least one of:
a maximum operation that selects a maximum of the first value and the second value;
a summation operation that sums the first value and the second value;
a median operation that determines a median of the first value and the second value; and
a minimum operation that selects a minimum of the first value and the second value.

17. The system of claim 11, wherein the instructions further cause the one or more processors to:
receive a data element comprising a first data element of the first data type and a second data element of the second data type;
extract first inference features of the first data element and second inference features of the second data element;
generate one or more merged features by combining one or more of the first inference features with one or more of the second inference features, wherein each of the one or more of the first inference features is a particular common feature to one of the one or more of the second inference features;
identify unique first classification features of the first classification features unique to the first data type;
identify unique second classification features of the second classification features unique to the second data type; and
generate a model output of the model by applying the one or more merged features, the unique first classification features, the unique second classification features as inputs to the model.

18. The system of claim 11, wherein:
the first data type is a text based data type and the second data type is at least one of an image data type or a video data type.

19. The system of claim 18, wherein:
at least a first portion of the plurality of first data elements are associated with first data element labels and at least a second portion of the plurality of second data elements are associated with second data element labels;
a first number of the first data element labels is greater than a second number of the second data element labels; and
the instructions further cause the one or more processors to train the model based on the first data element labels and the second data element labels.

20. The system of claim 18, wherein:
at least a first portion of the plurality of first data elements are associated with first data element labels and none of the plurality of second data elements are associated with second data element labels; and
the instructions further cause the one or more processors to train the model based on the first data element labels.
